(19) United States
(12) Patent Application Publication
(10) Pub. No.: US 2026/0351831 A1
(43) Pub. Date: Nov. 5, 2026

(54) STACKED BRANCH-LINE COUPLER

(71) Applicant: Huawei Technologies Co., Ltd., Shenzhen (CN)

(72) Inventor: Guohui Situ, Ottawa (CA)

(21) Appl. No.: 19/715,202

(22) Filed: Jun. 22, 2026

Related U.S. Application Data
(63) Continuation of application No. PCT/CN2024/073111, filed on Jan. 18, 2024.

(51) Int. Cl. H01P 5/22

(52) U.S. Cl. CPC H01P 5/227

(57) ABSTRACT

A stacked branch-line coupler for passively generating I/Q signals. The stacked branch-line coupler is formed in a multi-layer substrate and meandered series paths and meandered shunt paths are formed on separate layers. The meandered series path may be formed from a first portion and second portion, where the first and second portions are electrically in series and disposed on different layers of the substrate. The meandered shunt path may be formed from a first portion and second portion, where the first and second portions are electrically in series and disposed on different layers of the substrate. The layers with the shunt path portions may be different from the layer with the series path portions, such that the coupler is formed on at least four layers. The portions may be positioned in overlapping position in the layers of the substrate in a stacked manner.

### CROSS-REFERENCE TO RELATED APPLICATION

This application is a continuation of PCT Application No. PCT/CN2024/073111, entitled “STACKED BRANCH-LINE COUPLER,” filed on Jan. 18, 2024, which application is hereby incorporated herein by reference in its entirety.

### FIELD

The present application relates to passive I/Q signal generation and, in particular, to branch-line couplers.

### BACKGROUND

Modern communication systems often need to produce phase shifted signals. In many cases, for certain modulation types or for other purposes, a system may want to produce an in-phase signal and a quadrature-phase shifted signal from a common input signal. This is typically termed “I/Q generation”, to refer to the in-phase and quadrature-phase versions of the signal that are output from an I/Q generation circuit.

I/Q generation can be active or passive. Active I/Q generation can be more complex, less reliable, more prone to noise, and consumes extra power. Accordingly, passive I/Q generation may be preferrable for many implementations. One of the options for passive I/Q generation is a branch-line coupler in which the input signal passes through two passive impedance paths and there are two output ports: an in-phase output port and a quadrature-phase output port. In addition to the input port there is an isolation port. The paths are designed so as to result in a quarter wavelength phase shift at the quadrature-phase output port within the desired bandwidth versus the signal at the in-phase output port. The paths are also designed so as to have suitable reflection coefficients, insertion loss, phase imbalance, isolation, etc.

One of the drawbacks to passive I/Q generation using a branch-line coupler or similar circuits is the chip area required. It would be advantageous to have an improved passive I/Q generation circuit.

### BRIEF DESCRIPTION OF THE DRAWINGS

Reference will now be made, by way of example, to the accompanying drawings in which:

FIG. 1 shows an example of a simple branch-line coupler;

FIG. 2 shows a single layer meandered branch-line coupler;

FIG. 3 shows, in delayered form, an example of a stacked branch-line coupler;

FIG. 4 shows a top view of the stacked branch-line coupler of FIG. 3 in layered form;

FIG. 5 shows a second example of a stacked branch-line coupler in layered form;

FIG. 6 shows the second example of the stacked branch-line coupler of FIG. 5 in delayered form;

FIG. 7 shows a third example of a stacked branch-line coupler in layered form;

FIG. 8 shows the third example of the stacked branch-line coupler of FIG. 7 in delayered form;

FIG. 9 shows a fourth example of a stacked branch-line coupler in layered form; and

FIG. 10 shows the fourth example of the stacked branch-line coupler of FIG. 9 in delayered form.

Like reference numerals are used in the drawings to denote like elements and features.

### SUMMARY

In one aspect, the present application describes a stacked branch-line coupler for passive generation of I/Q signals. The coupler may include a multi-layer substrate having formed thereon an input port, an isolation port, an in-phase output port, and a quadrature-phase output port; a first meandered series path connecting the input port and the in-phase output port; a first meandered shunt path connecting the in-phase output port and the quadrature-phase output port; a second meandered series path connecting the isolation port and the quadrature-phase output port; and a second meandered shunt path connecting the input port and the isolation port. The meandered series paths may each have a first portion thereof formed on a first layer of the multi-layer substrate and a second portion thereof above the first portion and formed on a second layer of the multi-layer substrate. The meandered shunt paths may each have a first portion thereof formed on a third layer of the multi-layer substrate and a second portion thereof above the first portion and formed on a fourth layer of the multi-layer substrate.

In one implementation, the first portions and the second portions of the meandered shunt paths are disposed above, and at least partly overlap, the first portions and the second portions of the meandered series paths in the multi-layer substrate.

In one implementation, the first portions and the second portions of the meandered series paths are disposed above, and at least partly overlap, the first portions and the second portions of the meandered shunt paths in the multi-layer substrate.

In one implementation, each of the portions is formed on its respective layer in a stacked relation to the other portions.

In one implementation, the first portion of the meandered series path is connected in series to the second portion of the meandered series path by at least one via connecting the first layer to the second layer.

In one implementation, the first portion of the meandered shunt path is connected in series to the second portion of the meandered shunt path by at least one via connecting the third layer to the fourth layer.

In one implementation, each of the meandered series paths and the meandered shunt paths has two parallel spaced-apart traces to form a differential structure.

In one implementation, each of the meandered series paths and each of the meandered shunt paths has a length selected to be a quarter-wavelength of a design frequency for the stacked branch-line coupler.

In one implementation, the first portion of the first meandered series path includes a first part, a third part, and a fifth part, and wherein the second portion of the first meandered series path includes a second part and a fourth part, and wherein the respective parts are connected in series from the first part through to the fifth part. In some cases, each of the parts is connected to another part in the series on a different layer using one or more vias. In some cases, each of the parts of the first meandered series path is meandered.

In one implementation, the first portion of the first meandered shunt path includes a first part and a third part, and wherein the second portion of the first meandered shunt path includes a second part, and wherein the respective parts are connected in series from the first part through to the third part.

In one implementation the stacked branch-line coupler may further include respective impedances at the input port, the isolation port, the in-phase output port, and the quadrature-phase output port. In some cases, each of the meandered series paths and each of the meandered shunt paths has a length selected to be a respective fraction of a wavelength of a design frequency for the stacked branch-line coupler, the respective fractions being smaller than a quarter.

In one implementation, the meandered shunt paths each have one or more additional portions thereof formed on one or more additional layers of the multi-layer substrate, wherein the first portion of the meandered shunt paths and the second portion of the meandered shunt paths and each of the one or more additional portions of the meandered shunt paths are connected in series, and wherein each of the portions is formed on its respective layer in a stacked relation to the other portions.

In one implementation, the meandered series paths each have one or more additional portions thereof formed on one or more additional layers of the multi-layer substrate, wherein the first portion of the meandered series paths and the second portion of the meandered series paths and each of the one or more additional portions of the meandered series paths are connected in series, and wherein each of the portions is formed on its respective layer in a stacked relation to the other portions.

In one implementation, the multi-layer substrate includes an integrated circuit chip.

In one implementation, the multi-layer substrate includes a multi-level printed circuit board.

In one implementation, the multi-layer substrate includes a multi-level layered package.

In another aspect, the present application describes a stacked branch-line coupler for passive generation of I/Q signals that includes a multi-layer substrate having formed thereon an input port, an isolation port, an in-phase output port, and a quadrature-phase output port; and a pair of meandered series paths and a pair of meandered shunt paths, wherein the paths connect the input port, the isolation port, the in-phase output port, and the quadrature-phase output port in a branch-line coupler architecture. The pair of meandered series paths may each have a first portion thereof formed on a first layer of the multi-layer substrate and a second portion thereof above the first portion and formed on a second layer of the multi-layer substrate. The pair of meandered shunt paths may each have a first portion thereof formed on a third layer of the multi-layer substrate and a second portion thereof above the first portion and formed on a fourth layer of the multi-layer substrate.

Other aspects and features of the present application will be understood by those of ordinary skill in the art from a review of the following description of examples in conjunction with the accompanying figures.

### DETAILED DESCRIPTION

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements. The term “and/or” is intended to indicate that either of the two elements may be included or both of the elements may be included.

In wireless communications, for many applications, an input signal may be used to generate an in-phase signal and a quadrature-phase shifted signal, i.e. I/Q signals. I/Q generation can be active or passive. One of the options for passive I/Q generation is a branch-line coupler in which the input signal passes through two passive impedance paths and there are two output ports: an in-phase output port and a quadrature-phase output port. In addition to the input port there is an isolation port. The paths are selected such that a quarter wavelength phase shift appears in the signal at the quadrature-phase output port within the desired bandwidth versus the signal at the in-phase output port. The paths are also designed so as to have suitable reflection coefficients, insertion loss, phase imbalance, isolation, and other such parameters.

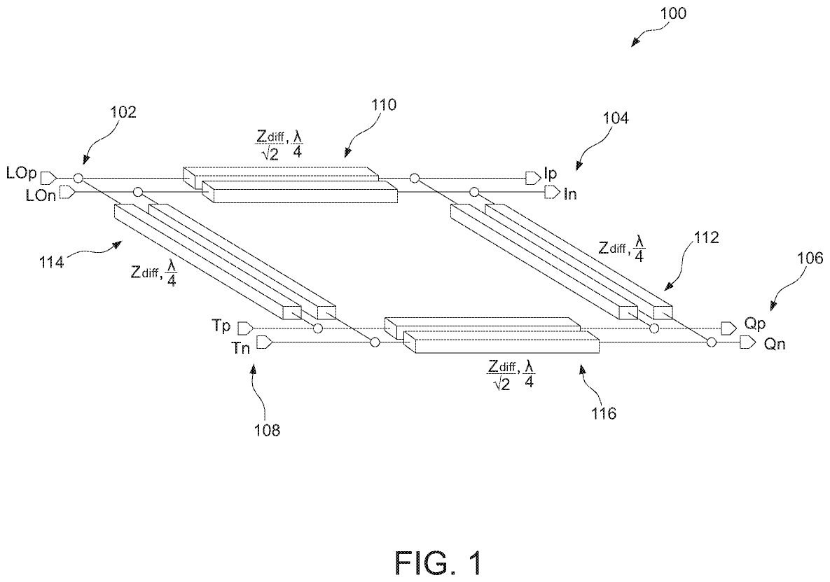

Reference is made to FIG. 1, which shows an example branch-line coupler (BLC) 100. In this example, the BLC 100 is a differential BLC, but a similar architecture may be used for a single ended design rather than a differential design. The essential idea of a passive I/Q BLC is to cause a quarter wave length phase shift through having a quarter wave length transmission line inserted in the signal path to the quadrature-phase output port.

The BLC 100 includes an input port 102 (LOp and LOn), which in this example is a differential input port having positive and negative terminals. The BLC 100 further includes an in-phase output port 104 (Ip and In), a quadrature-phase output port 106 (Qp and Qn), and an isolation port 108 (Tp and Tn). The input port 102 is connected to the in-phase output port 104 by a first series path 110, wherein the length of the first series path 110 is

$$\frac{λ}{4} ,$$

λ is the wave length, and the impedance of the first series path 110 is

$$\frac{{Z}_{diff}}{\sqrt{2}} ,$$

Z_{diff} is a nominal differential impedance. The in-phase output port 104 is connected to the quadrature-phase output port 106 by a first shunt path 112, wherein the length of the first shunt path 112 is

$$\frac{λ}{4}$$

and the impedance of the first shunt path 112 is Z_{diff}. The input port 102 is connected to the isolation port 108 by a second shunt path 114, wherein the length of the second shunt path 114 is

$$\frac{λ}{4}$$

and the impedance of the second shunt path 114 is Z_{diff}, and the isolation port 108 is connected to the quadrature-phase output port 106 by a second series path 116, wherein the length of the second series patn 110 is

$$\frac{λ}{4}$$

and the impedance of the second series path 116 is

$$\frac{{Z}_{diff}}{\sqrt{2}} .$$

It will be noted that the first and second shunt paths 112, 114 in this example are quarter-wavelength transmission lines. The impedances of the various paths 110, 112, 114, 116 are selected to result in desired insertion loss, reflection coefficients, phase imbalance, and other such characteristics.

One of the drawbacks to passive I/Q generation using a branch-line coupler or similar circuits is the chip area required. One technique for reducing the chip area is to use meandered paths for the transmission lines. Another technique is to introduce reactance, such as shunt capacitance, at the ports, which can shorten the transmission line length needed. The downside of using reactance at the ports is that process variation can reduce manufacturing consistency.

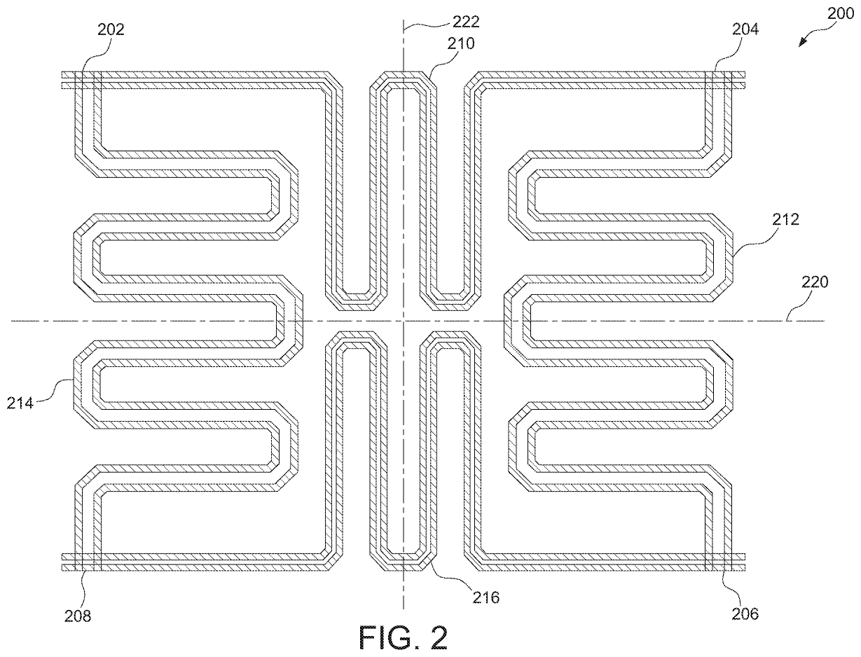

Reference is now made to FIG. 2, which shows a diagrammatic example of a meandered branch-line coupler (MBLC) 200. The MBLC 200 in this example has a differential structure with parallel spaced-apart traces for positive and negative inputs. The MBLC 200 includes an input port 202, an in-phase output port 204, a quadrature-phase output port 206, and an isolation port 208.

The input port 202 is connected to the in-phase output port 204 by a first meandered series path 210. The in-phase output port 204 is connected to the quadrature-phase output port 206 by a first meandered shunt path 212. The input port 202 is connected to the isolation port 208 by a second meandered shunt path 214. The isolation port 208 is connected to the quadrature-phase output port 206 by a second meandered series path 216.

The meandered series paths 210, 216 in this example include two meandered loops extending towards a midline 220 of the MBLC 200 in a switchback meander. The midline 220 in this example bisects the shunt paths 212, 214 and lies between the input port 202 and the isolation port 208, and also between the in-phase output port 204 and the quadrature-phase output port 206.

Similarly, the two meandered shunt paths 212, 214 in this example include three meandered loops extending towards a transverse midline 222 of the MBLC 200 in a switchback meander. The transverse midline 222 bisects the series paths 210, 216 and lies between the input port 202 and the in-phase output port 204, and also between the isolation port 208 and the quadrature-phase output port 206.

The meandering results in a significant reduction in the overall chip area consumed by the MBLC 200 versus the BLC 100 (FIG. 1). In some cases, the path impedance may be selected or adjusted through changes to the metal used or the width of the metal traces used in forming the paths. In this manner, through selection and arrangement of the meander paths, the path length, the trace width and other characteristics, the MBLC 200 may be designed to meet desired parameters in terms of frequency band, reflection, insertion loss, phase imbalance, and amplitude imbalance.

The example MBLC 200 shown in FIG. 2 may be designed for use in the 37.45 GHz to 42.45 GHz frequency band. In some implementations, it may have an overall size of about 320 micrometers by 440 micrometers. The insertion loss may range from −3.7 to −5.2 dB and the phase shift may range from 88 to 92 degrees across the operating frequency band. The amplitude imbalance may range from 1.1 to 1.4 dB.

It would still be advantageous to improve upon the chip area consumed by the MBLC 200.

In accordance with one aspect of the present application, the chip area may be significantly reduced in the context of a multi-layer substrate through folding or stacking of the branch-line couplers such that portions of the series and/or shunt paths are distributed across two or more of the layers. In many cases, the portions may be disposed partly or wholly atop one another in the layers of the multi-layer substrate. The resulting structure may be referred to as a folded branch-line coupler or a stacked branch-line coupler. The multi-layer substrate may be within an integrated circuit chip in some cases, or may be a multi-layer printed circuit board in some cases, or may be any other multi-level layered package.

In one illustrative example, the MBLC 200 may be folded or stacked such that a portion of either the series paths 210, 216 or the shunt paths 212, 214, or both, are disposed on different layers of a multi-layer substrate. The folding or stacking may be about the midline 220 in some cases. The folding or stacking may be about the transverse midline 222 in some cases. In some examples, the folding or stacking may be along lines other than the midlines 220, 222. In some examples, the folding or stacking may distribute one or both of the paths across three or more layers of a multi-layer substrate. The different portions of the paths disposed on different layers may be connected by way of vias or other suitable inter-layer metal connections.

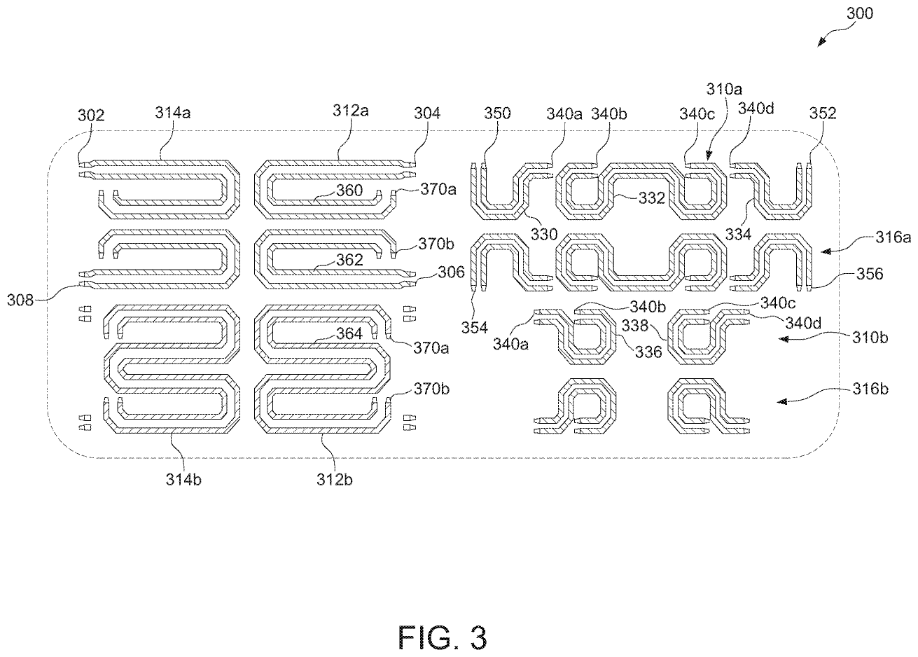

Reference is now made to FIG. 3, which diagrammatically illustrates one example of a stacked branch-line coupler (SBLC) 300. For ease of illustration, the SBLC 300 is shown with the layers separated rather than overlaid. The SBLC 300 includes an input port 302, an in-phase output port 304, a quadrature-phase output port 306, and an isolation port 308. In this example, all the ports are shown as being on the same layer; however, as will be explained below they are connected to multiple layers and the connection between a particular port and external signal paths or components may occur at any one of the layers depending on the implementation.

The SBLC 300 in this example is disposed on four layers of a multi-layer substrate. In this specific example, the multi-layer substrate is implemented using STMicroelectronics 55 nm BiCMOS technology and a substrate with eight or more layers. In this example the SBLC 300 is implemented on layers M5 through M8, although the present application is not limited to this technology or these particular layers or metal types.

In this example, the SBLC 300 includes first and second meandered series paths disposed on the M6 and M5 layers. A first portion of the first meandered series path 310a and a first portion of the second meandered series path 316a may be disposed on one layer, such as the M6 layer, and a second portion of the first meandered series path 310b and a second portion of the second meandered series path 316b may be disposed on another layer, such as the M5 layer. The first portions 310a and 316a are electrically connected in series with the respective second portions 310b and 316b. In this particular example the first portion of the first meandered series path 310a includes a first part 330, a third part 332 and a fifth part 334 of the path in one layer. The second portion of the first meandered series path 310b includes a second part 336 and a fourth part 338 of the path in the other layer. Vias 340 (shown individually as 340a, 340b, . . . ) connect the first part 330 to the second part 336, and the second part 336 to the third part 332, and the third part 332 to the fourth part 338, and the fourth part 338 to the fifth part 334, all in series to form the first meandered series path.

Although FIG. 3 shows the layers side by side for ease of explanation, it will be appreciated that layer M5 sits under layer M6 such that the first portion of the first meandered series path 310a is above and atop the second portion of the first meandered series path 310b, such that the vias 340 electrically connect the various parts of the path. For instance, one end of the first part 330 of the path is connected to an end of the second part 336 of the path through via 340a. Each of the parts 330, 332, 334, 336, 338 in this example is formed as a meandered path.

The first portion of the second meandered series path 316a is disposed on the M6 layer and the second portion of the second meandered series path 316b is disposed on the M5 layer. In this example, the second portion is disposed below the first portion and electrically connected using vias.

The first portion of the first meandered series path 310a includes vias 350 at one end that connect it to the input port 302 which is disposed directly above that one end in the multi-layer substrate. The first portion of the first meandered series path 310a also includes vias 352 at its other end that connect it to the in-phase output port 304. Thus, the first meandered series path formed by the first portion 310a and the second portion 310b connect the input port 302 to the in-phase output port 304.

The first portion of the second meandered series path 316a includes vias 354 at one end that connect it to the isolation port 308 which is disposed directly above that one end in the multi-layer substrate. The first portion of the second meandered series path 316a also includes vias 356 at its other end that connect it to the quadrature-phase output port 306. Thus, the second meandered series path formed by the first portion 316a and the second portion 316b connect the isolation port 308 to the quadrature-phase output port 306.

The SBLC 300 in this example includes first and second meandered shunt paths disposed on the M7 and M8 layers. A first portion of the first meandered shunt path 312a and a first portion of the second meandered shunt path 314a may be disposed on one layer, such as the M7 layer, and a second portion of the first meandered shunt path 312b and a second portion of the second meandered shunt path 314b may be disposed on another layer, such as the M8 layer. The first portions 312a and 314a are electrically connected in series with the respective second portions 312b and 314b. In this particular example the first portion of the first meandered shunt path 312a includes a first part 360 and a third part 362 of the path in one layer. The second portion of the first meandered shunt path 312b includes a second part 364 of the path in the other layer. Vias 370 (shown individually as 370a, 370b) connect the first part 360 to the second part 364, and the second part 364 to the third part 362, all in series to form the first meandered shunt path.

Although FIG. 3 shows the layers side by side for ease of explanation, it will be appreciated that layer M7 sits under layer M8 such that the first portion of the first meandered shunt path 312a is below and beneath the second portion of the first meandered shunt path 312b, such that the vias 370 electrically connect the various parts of the path. For instance, one end of the first part 360 of the path is connected to an end of the second part 364 of the path through via 370a, and the other end of the second part 364 of the path is connected to the third part 362 through via 370b. Each of the parts 360, 362, 364 in this example is formed as a meandered path.

The first portion of the second meandered shunt path 314a is disposed on the M7 layer and the second portion of the second meandered shunt path 314b is disposed on the M8 layer. In this example, the second portion is disposed above the first portion and electrically connected using vias.

In this example, the first portion of the first meandered shunt path 312a is electrically connected to the in-phase output port 304 and to the vias 352 that connect the in-phase output port 304 to the first meandered series path. The first portion of the first meandered shunt path 312a is also connected to the quadrature-phase output port 306 at its other end. Thus, the first meandered shunt path formed by the first portion 312a and the second portion 312b connect the in-phase output port 304 to the quadrature-phase output port 306.

The first portion of the second meandered shunt path 314a is electrically connected to the input port 302 and to the vias 350 that connect the input port 302 to the first meandered series path. The first portion of the second meandered shunt path 314a is also connected at its other end to the isolation port 308. Thus, the second meandered shunt path formed by the first portion 314a and the second portion 314b connect the input port 302 to the isolation port 308.

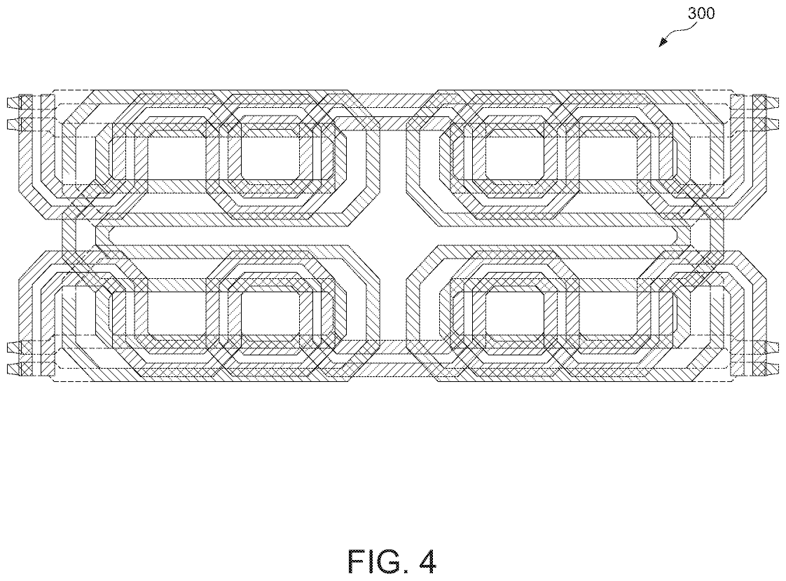

Reference is now also made to FIG. 4 which shows a top view of the SBLC 300 with its various traces shown in layered position one atop the other as they would be arranged in a multi-layer substrate. The footprint of the SBLC 300, although on multiple layers, is significantly smaller than a branch-line coupler formed in a single layer, even if meandering is used in forming the transmission line traces. For example, the illustrated SBLC 300 designed to operate in the 37.45 GHz to 42.45 GHz range may occupy a chip area of about 92 micrometers×248 micrometers. This is an area of about 22,816 square micrometers, whereas an equivalent single layer meandered BLC may occupy an area of about 140,800 square micrometers. In other words, the SBLC 300 has area of only about 16% that of the equivalent single layer meandered BLC. Accordingly, even though it occupies 4 layers, it results in a significant savings of chip real estate.

The example SBLC 300 in simulations has an insertion loss of about −5.47 to −5.76 dB, a phase shift of 86 to 94 degrees within the operating bandwidth, and an amplitude imbalance ranging from 0.14 to 0.3 dB.

It will be noted that the example SBLC 300 has not been folded or stacked to the same degree in both x and y directions. In this example, the bias is towards folding or stacking in the y direction, in part because the specific application for which it is intended, such as a multi-beam phased array transmitter, has greater stress in terms of chip real estate constraints in one direction versus another, so a somewhat rectangular layout may be advantageous. In applications where many of the same circuit may be arranged in parallel it may be advantageous to have them adopt a rectangular shape with the inputs and outputs on opposite ends of the longer side of the rectangle. In other implementations, a stacking that results in a square layout may be more advantageous.

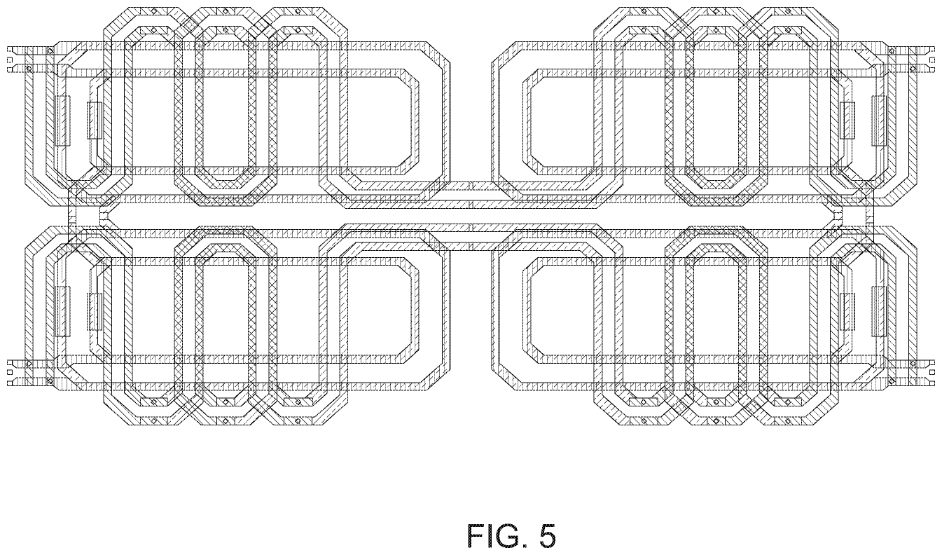

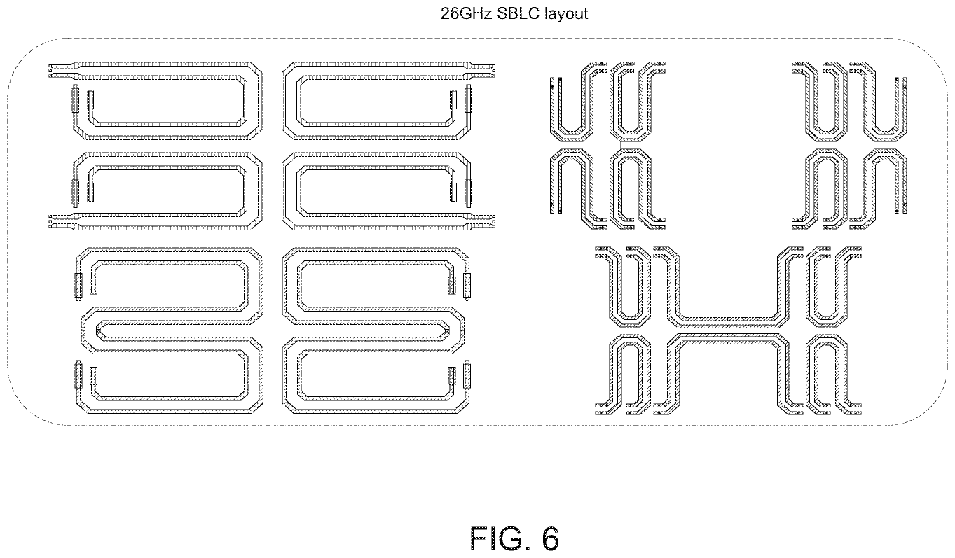

Reference is now made to FIGS. 5-10. FIG. 5 shows one example of a stacked branch-line coupler designed to operate in the 26 GHz range. FIG. 6 shows the stacked branch-line coupler of FIG. 5 in a delayered form.

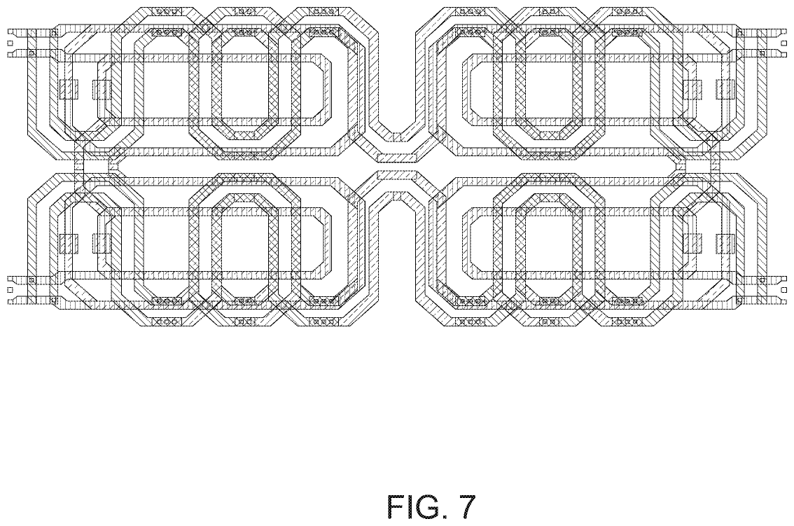

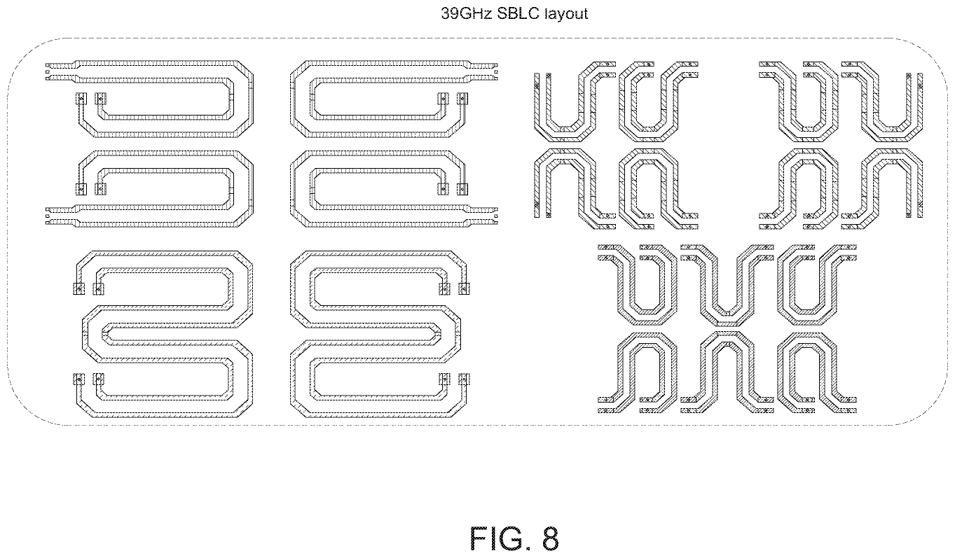

FIG. 7 shows one example of a stacked branch-line coupler designed to operate in the 39 GHz range. FIG. 8 shows the stacked branch-line coupler of FIG. 7 in a delayered form.

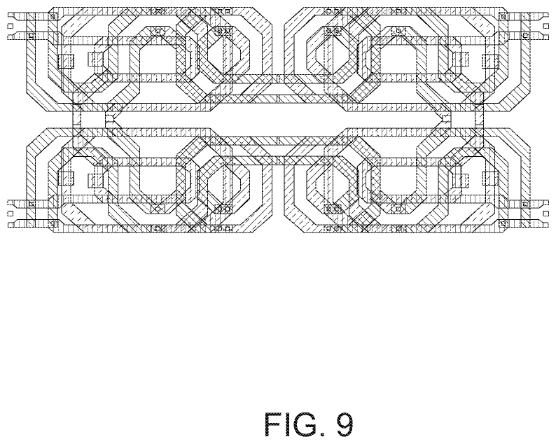

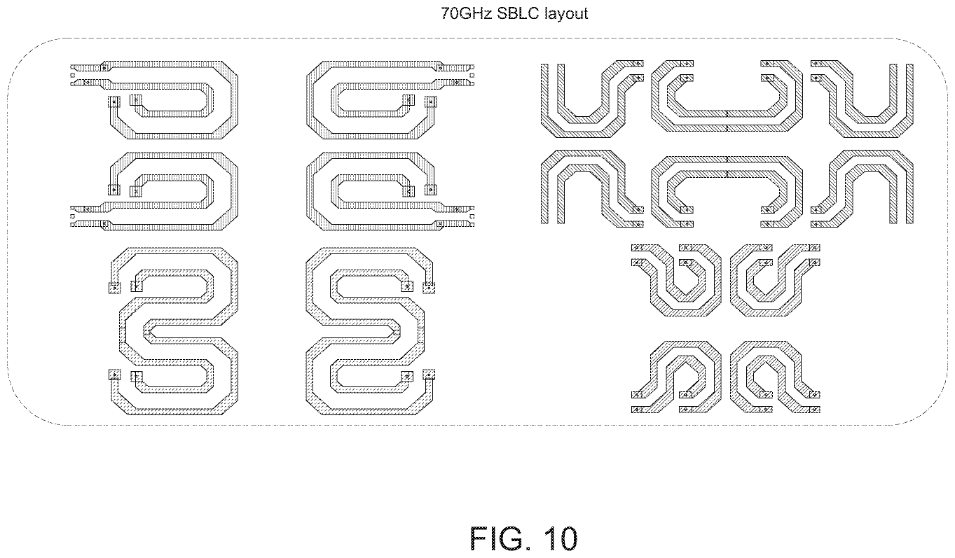

FIG. 9 shows one example of a stacked branch-line coupler designed to operate in the 60-80 GHz range. FIG. 10 shows the stacked branch-line coupler of FIG. 9 in a delayered form.

The above example illustrations of stacked branch-line couplers are all in differential form, i.e. with parallel signal traces in all the paths for positive and negative signals. It will be appreciated that the same architecture may be used in the case of single ended implementations and that the present application is not limited to differential branch-line couplers.

It will also be appreciated that the stacked branch-line coupler may be implemented in any multi-layer substrate. The multi-layer substrate may be a printed circuit board in some cases. The substrate may be an integrated circuit chip. The substrate may be implemented using any other multi-layer package. In one specific example, the stacked branch-line coupler may be formed within a chip implemented using BiCMOS technology.

In some implementations, further size reductions for the stacked branch-line coupler may be achieved by adding respective impedance to the four ports, that is to the input port, the isolation port, the in-phase output port, and the quadrature-phase output port. The impedance enables the reduction in the length of the series and shunt signal paths; however, adding impedance introduces a heightened risk of some process variation. The impedance may include resistance or reactance, such as capacitance. By adding impedance at the input ports and output ports, the length of the series and shunt signal paths may be reduced to a fraction of a wavelength smaller than one quarter of the wavelength.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A stacked branch-line coupler for passive generation of in-phase and quadrature (I/Q) signals, comprising:
a multi-layer substrate having formed thereon an input port, an isolation port, an in-phase output port, and a quadrature-phase output port;
a first meandered series path connecting the input port and the in-phase output port;
a first meandered shunt path connecting the in-phase output port and the quadrature-phase output port;
a second meandered series path connecting the isolation port and the quadrature-phase output port; and
a second meandered shunt path connecting the input port and the isolation port,
wherein the first meandered series path and the second meandered series path each have a first portion thereof formed on a first layer of the multi-layer substrate and a second portion thereof above the first portion and formed on a second layer of the multi-layer substrate, and
wherein the first meandered shunt path and the second meandered shunt path each have a first portion thereof formed on a third layer of the multi-layer substrate and a second portion thereof above the first portion and formed on a fourth layer of the multi-layer substrate.

2. The stacked branch-line coupler of claim 1, wherein corresponding first portions and corresponding second portions of the first meandered shunt path and the second meandered shunt path are disposed above, and at least partly overlap, corresponding first portions and corresponding second portions of the first meandered series path and the second meandered series path in the multi-layer substrate.

3. The stacked branch-line coupler of claim 1, wherein corresponding first portions and corresponding second portions of the first meandered series path and the second meandered series path are disposed above, and at least partly overlap, corresponding first portions and corresponding second portions of the first meandered shunt path and the second meandered shunt path in the multi-layer substrate.

4. The stacked branch-line coupler of claim 1, wherein each of corresponding first portions and corresponding second portions of the first meandered series path and the second meandered series path and corresponding first portions and corresponding second portions of the first meandered shunt path and the second meandered shunt path is formed on a respective layer in a stacked relation to other portions.

5. The stacked branch-line coupler of claim 1, wherein the first portion of at least one of the first meandered series path or the second meandered series path is connected in series to the second portion of the at least one of the first meandered series path or the second meandered series path by at least one via connecting the first layer to the second layer.

6. The stacked branch-line coupler of claim 1, wherein the first portion of at least one of the first meandered shunt path or the second meandered shunt path is connected in series to the second portion of the at least one of the first meandered shunt path or the second meandered shunt path by at least one via connecting the third layer to the fourth layer.

7. The stacked branch-line coupler of claim 1, wherein each of the first meandered series path, the second meandered series path, the first meandered shunt path, and the second meandered shunt path includes two parallel spaced-apart traces to form a differential structure.

8. The stacked branch-line coupler of claim 1, wherein a respective length of each of the first meandered series path, the second meandered series path, the first meandered shunt path, and the second meandered shunt path is selected to be a quarter-wavelength of a design frequency for the stacked branch-line coupler.

9. The stacked branch-line coupler of claim 1, wherein the first portion of the first meandered series path includes a first part, a third part, and a fifth part, and wherein the second portion of the first meandered series path includes a second part and a fourth part, and wherein the first part, the second part, the third part, the fourth part, and the fifth part are connected in series from the first part through to the fifth part.

10. The stacked branch-line coupler of claim 9, wherein each of the first part, the second part, the third part, the fourth part, and the fifth part is connected to another part in the series on a different layer using one or more vias.

11. The stacked branch-line coupler of claim 9, wherein each of the first part, the third part, and the fifth part of the first meandered series path is meandered.

12. The stacked branch-line coupler of claim 1, wherein the first portion of the first meandered shunt path includes a first part and a third part, and wherein the second portion of the first meandered shunt path includes a second part, and wherein the first part, the second part, and the third part are connected in series from the first part through to the third part.

13. The stacked branch-line coupler of claim 1, further comprising respective impedances at the input port, the isolation port, the in-phase output port, and the quadrature-phase output port.

14. The stacked branch-line coupler of claim 13, wherein a respective length of each of the first meandered series path, the second meandered series path, the first meandered shunt path, and the second meandered shunt path is selected to be a respective fraction of a wavelength of a design frequency for the stacked branch-line coupler, the respective fraction being smaller than a quarter.

15. The stacked branch-line coupler of claim 1, wherein the first meandered shunt path and the second meandered shunt path each include one or more additional portions thereof formed on one or more additional layers of the multi-layer substrate, wherein corresponding first portions of the first meandered shunt path and the second meandered shunt path and corresponding second portions of the first meandered shunt path and the second meandered shunt path and each of the one or more additional portions of the first meandered shunt path and the second meandered shunt path are connected in series, and wherein each of the corresponding first portions, the corresponding second portions, and the one or more additional portions is formed on a respective layer in a stacked relation to the other portions.

16. The stacked branch-line coupler of claim 1, wherein the first meandered series path and the second meandered series path each include one or more additional portions thereof formed on one or more additional layers of the multi-layer substrate, wherein corresponding first portions of the first meandered series path and the second meandered series path and corresponding second portions of the first meandered series path and the second meandered series path and each of the one or more additional portions of the first meandered series path and the second meandered series path are connected in series, and wherein each of the corresponding first portions, the corresponding second portions, and the one or more additional portions is formed on its respective layer in a stacked relation to the other portions.

17. The stacked branch-line coupler of claim 1, wherein the multi-layer substrate includes an integrated circuit chip.

18. The stacked branch-line coupler of claim 1, wherein the multi-layer substrate includes a multi-level printed circuit board.

19. The stacked branch-line coupler of claim 1, wherein the multi-layer substrate includes a multi-level layered package.

20. A stacked branch-line coupler for passive generation of in-phase and quadrature (I/Q) signals, comprising:
a multi-layer substrate having formed thereon an input port, an isolation port, an in-phase output port, and a quadrature-phase output port; and
a pair of meandered series paths and a pair of meandered shunt paths, wherein the pair of meandered series paths and the pair of meandered shunt paths connect the input port, the isolation port, the in-phase output port, and the quadrature-phase output port in a branch-line coupler architecture,
wherein the pair of meandered series paths each include a first portion thereof formed on a first layer of the multi-layer substrate and a second portion thereof above the first portion and formed on a second layer of the multi-layer substrate, and
wherein the pair of meandered shunt paths each include a first portion thereof formed on a third layer of the multi-layer substrate and a second portion thereof above the first portion and formed on a fourth layer of the multi-layer substrate.
